(19) United States
(12) Patent Application Publication
(10) Pub. No.: US 2026/0170464 A1
(43) Pub. Date: Jun. 18, 2026

(54) MEETING ATTENDENCE TYPE IDENTIFICATION

(71) Applicant: Lenovo Global Technology (United States) Inc., Morrisville, NC (US)

(72) Inventors: Mark Delaney, Raleigh, NC (US); Nathan Peterson, Oxford, NC (US); John C. Mese, Cary, NC (US); Russell S. VanBlon, Raleigh, NC (US)

(21) Appl. No.: 18/978,957

(22) Filed: Dec. 12, 2024

(51) Int. Cl. G06Q 10/1093

(52) U.S. Cl. CPC G06Q 10/1093

(57) ABSTRACT

One embodiment provides a method, the method including: identifying, using a meeting type identification system, a meeting scheduled for a user; determining, using the meeting type identification system and based upon factors of the meeting, an attendee appearance type identifying how the user should appear at the meeting; and providing, to the user, a recommendation related to the meeting in view of the attendee appearance type for the meeting. Other aspects are claimed and described.

### BACKGROUND

Many people, particularly those that work with or otherwise interface with other people, are required to attend meetings. Different companies may have different policies regarding meetings and how the meetings are to be attended. Many companies allow meetings to be attended virtually or physically. For example, a meeting with a boss of the user may need to be an in-person meeting. Virtual meetings can be attended either with an enabled image capture feed or a disabled image capture feed. With an enabled image capture feed, video of the user will be captured and transmitted to other attendees of the virtual meeting. For example, a meeting where a user is meeting with internal team members may be a virtual meeting with the video capture feed enabled. With a disabled image capture feed, no video of the user will be captured. For example, a meeting where an entity is presenting a presentation to a large number of attendees may be a virtual meeting with the video capture feed disabled. Depending on the type of the meeting, a user may need to make different preparations with regard to the meeting.

### BRIEF SUMMARY

In summary, one aspect provides a method, the method including: identifying, using a meeting type identification system, a meeting scheduled for a user; determining, using the meeting type identification system and based upon factors of the meeting, an attendee appearance type identifying how the user should appear at the meeting; and providing, to the user, a recommendation related to the meeting in view of the attendee appearance type for the meeting.

Another aspect provides a system, the system including: a processor; a memory device that stores instructions that, when executed by the processor, causes the system to: identify, using a meeting type identification system, a meeting scheduled for a user; determine, using the meeting type identification system and based upon factors of the meeting, an attendee appearance type identifying how the user should appear at the meeting; and provide, to the user, a recommendation related to the meeting in view of the attendee appearance type for the meeting.

A further aspect provides a product, the product including: a computer-readable storage device that stores executable code that, when executed by a processor, causes the product to: identify, using a meeting type identification system, a meeting scheduled for a user; determine, using the meeting type identification system and based upon factors of the meeting, an attendee appearance type identifying how the user should appear at the meeting; and provide, to the user, a recommendation related to the meeting in view of the attendee appearance type for the meeting.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing a recommendation to a user related to a meeting scheduled for the user and in view of an attendee appearance type that is determined based upon factors of the meeting.

### DETAILED DESCRIPTION

Whether the user can attend a meeting virtually or has to appear for an in-person meeting may be dependent on different factors. Similarly, whether the user has to have an image capture feed activated or can keep it deactivated may be dependent on different factors. For example, the company for which either the user or other attendees of the meeting work may have a policy regarding whether meetings must be in-person or virtual and, if virtual, a policy regarding the use of the image capture feed. As another example, meetings with different attendees, meetings for different topics, and/or the like, may dictate the attendee appearance type (e.g., in-person, virtual with video enabled, virtual with video disabled, etc.) for the meeting. It can be difficult to remember how an attendee is supposed to appear at any particular meeting.

Additionally, when a user is looking at a schedule for a particular day, it may be difficult for the user to plan their day with respect to which meetings need to be in-person meetings, which meetings are virtual meetings with a camera feed enabled, and which meetings are virtual meetings with a camera feed disabled. In other words, taking a quick look through a schedule for a particular day, the user has to recall the meeting and then recall the expectation regarding an appearance of the user at the meeting. Since the user is only focusing on a particular meeting for a short period of time, it may be difficult to accurately identify how the user should appear at a particular meeting. This may result in the user not being properly prepared for a particular meeting when it is time for the user to attend the meeting.

For example, for in-person meetings the user may need to allocate time to get properly prepared for the meeting, travel to the meeting location, find the meeting location within the building, set up and test any necessary meeting equipment, and/or the like. As another example, for a virtual camera enabled meeting, the user may need to allocate time to properly dress for the meeting, make sure the location where the user will be utilizing looks presentable, test equipment, and/or the like. As a final example, for a virtual camera disabled meeting, the user may only need to allocate time to test the meeting equipment, make sure the space is free from outside noises, and/or the like. Thus, if a person prepares for a meeting that the person thought was a virtual camera disabled meeting, when it is actually an in-person meeting, the person will not have enough time to properly prepare and arrive at the meeting location. Conversely, if a person prepares for an in-person meeting that is actually a virtual camera enabled meeting, the person spent a significant amount of time preparing that was not needed.

Currently, the only techniques for determining meeting attendance types rely on the user to properly identify how the user should attend the meeting. For users who have never attended a meeting with particular attendees or to cover particular topics, the user has to ask other attendees what the expectations are with respect to the attendee appearance type. However, the user may not know any of the other attendees, may not have access to other attendees, and/or other complications that can make it difficult for the user to ascertain the attendance type expectations. This may lead to the attendee having to guess what the expectations are. If the user is unable to make an educated guess for one reason or another, the attendee may default to the most conservative approach which is likely an in-person meeting. However, this may mean that the attendee is driving to a physical location, and the attendee may discover that the meeting is actually a virtual meeting, which means that the attendee wasted time getting to a meeting location.

Accordingly, the described system and method provides a technique for providing a recommendation to a user related to a meeting scheduled for the user and in view of an attendee appearance type that is determined based upon factors of the meeting. The system may identify a meeting scheduled for a user. Identifying a meeting may include accessing a calendar, schedule, meeting conference application, or other application that may contain information related to meetings of a user. The system can then identify the meetings that are scheduled for the user and identify information related to the meeting, for example, the attendees of the meeting, the location of the meeting, the time of the meeting, topic of the meeting, roles of attendees, locations of attendees of the meeting, and/or the like. The identified information, plus other information, may be considered to be factors of the meeting. Thus, factors of the meeting may include any of the above identified information and other information, for example, historical patterns of attendance type for similar meetings, historical attendance type by other attendees for similar meetings, crowdsourced information related to meetings, and/or the like.

Based upon the factors of the meeting, the system can determine an attendee appearance type identifying how the user should appear at the meeting. Thus, the system can determine if the meeting is an in-person, virtual with camera enabled, virtual with camera disabled, and/or the like, type of meeting. In view of the attendee appearance type for the meeting, the system can provide a recommendation related to the meeting to the user. The recommendation may include not only identifying the attendee appearance type, but can also include recommendations regarding how much time a user will need to prepare for attending the meeting, recommendations to set reminders to perform particular tasks, recommendations to move meetings to different times and/or days, recommendations regarding when to travel to different meetings, and/or the like. The system could provide the recommendation within a graphical user interface. For example, in providing a recommendation regarding the attendee appearance type, the system could present an overlay on the schedule or calendar of the user that designates each of the meetings on the schedule or calendar as one of the meeting attendance types. The user can then quickly look at the schedule and identify the meeting types without having to spend a significant length of time analyzing each meeting.

Therefore, a system provides a technical improvement over traditional methods for determining how an attendee should appear at a scheduled meeting. Instead of relying on a user to remember and accurately identify how to appear at a meeting, the described system and method is able to determine the attendee appearance type based upon different factors of the meeting. Additionally, since the system can access historical information from not just the user or attendee, but also from other attendees or entity information, the system is able to provide recommendations for attendee appearance types for attendees who may not have ever attended the meeting or a similar meeting previously. The system is not only able to provide recommendations regarding how a user should look or attend a meeting, but is also able to provide recommendations regarding how much time a user should allocate to preparing for and getting to the meeting, when a user should go to a particular location, if meetings should be moved to other days or times, and/or the like. Thus, the described system is able to provide recommendations for meetings to an attendee that result in more accurate meeting attendance, promotes better meeting preparedness, provides a better user experience, and enhances overall connectivity between attendees as compared to traditional, manual techniques for identifying a meeting attendance type.

The illustrated example embodiments will be best understood by reference to the figures. The following description is intended only by way of example, and simply illustrates certain example embodiments.

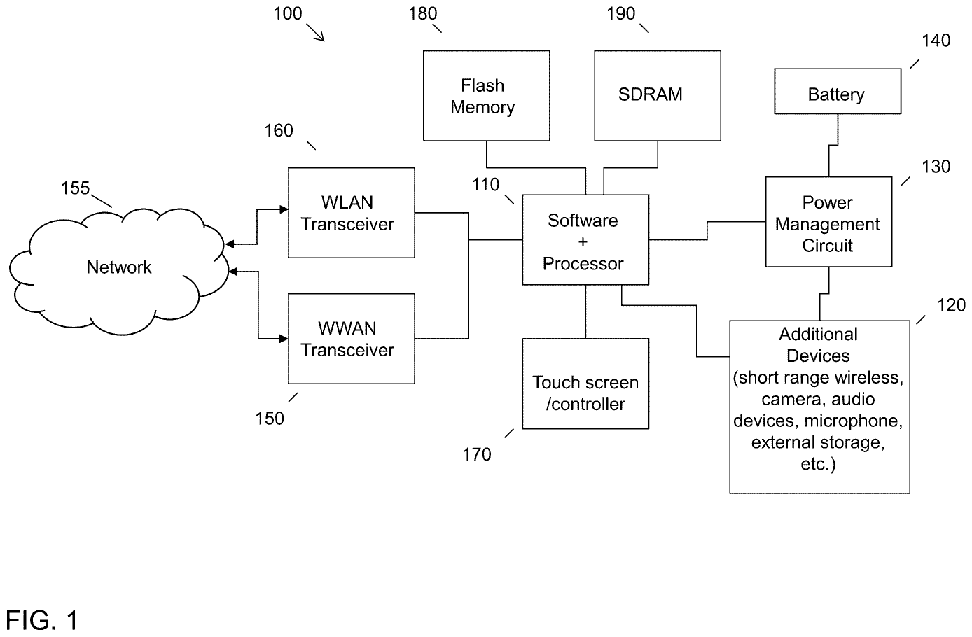

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

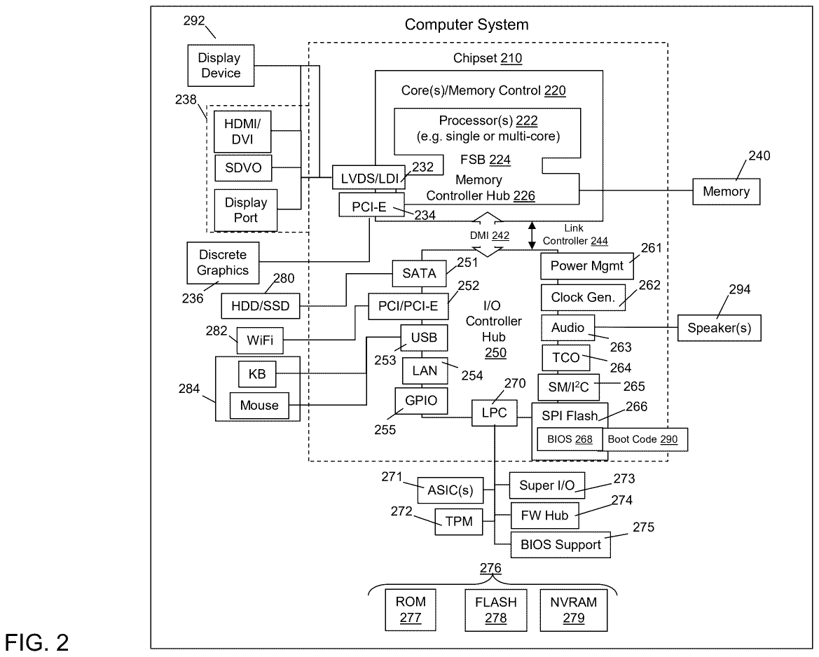

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices which are utilized to access virtual meetings, to contain a schedule for a user, house or provide access to the meeting type identification system, and/or the like. For example, the circuitry outlined in FIG. 1 may be implemented in a tablet or smart phone embodiment, whereas the circuitry outlined in FIG. 2 may be implemented in a personal computer embodiment.

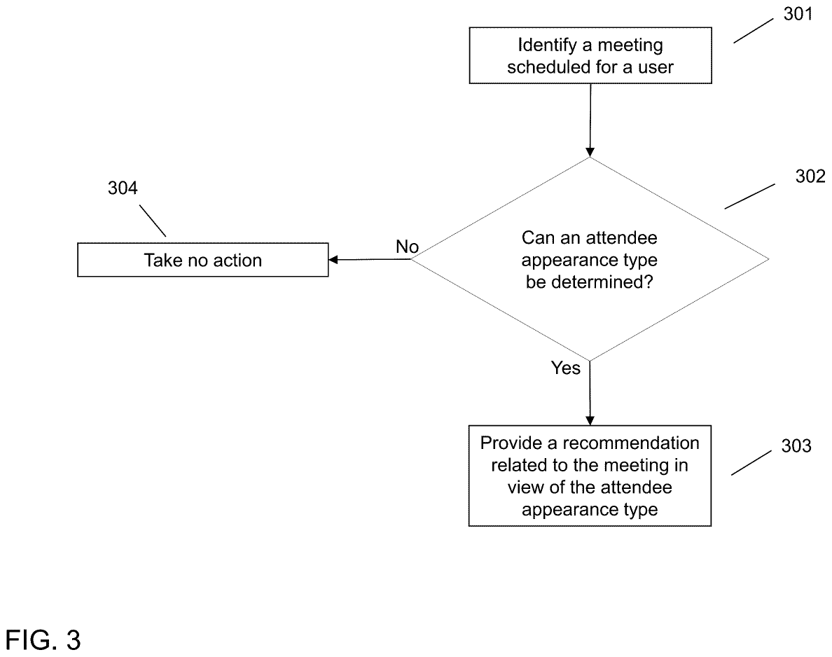

FIG. 3 illustrates an example method for providing a recommendation to a user related to a meeting scheduled for the user and in view of an attendee appearance type that is determined based upon factors of the meeting. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to determine an attendee appearance type for a meeting and provide recommendations for the meeting. Additionally, the meeting type identification system includes modules and features that are unique to the described system.

The meeting type identification system may be activated in order to determine an attendee appearance type that identifies how a user should appear at a meeting. In other words, the system is able to identify the attendee appearance type that allows a user to determine how to prepare for the meeting, for example, by accounting for getting ready and dressed appropriately for the meeting, commuting to a meeting location, ensuring a meeting space is presentable in both visual and audio appearance, testing any necessary hardware and/or software, and/or the like. The system is able to identify a meeting that is scheduled for a user and then identify factors of the meeting that will provide insight into the attendee appearance type. Once the system has determined the attendee appearance type, the system can provide recommendations to the user that are related to the meeting and that are in view of the attendee appearance type for the meeting.

Activation of the meeting type identification system may be a manual activation of the meeting type identification system and/or an automatic activation of the meeting type identification system. Manual activation of the system may include a user opening an application associated with the meeting type identification system, the user accessing the computing system associated with the meeting type identification system, and/or the user otherwise providing input to the meeting type identification system. The automatic activation of the meeting type identification system may be based upon the detection of a trigger event indicating that the system should be activated. Example trigger events include automatic identification of a meeting scheduled for a user, a user accessing a calendar or schedule, a user providing input (e.g., audible, visual, gesture, etc.) indicating the user needs or wants to know an attendee appearance type for a meeting, a user accessing an application that interfaces with the meeting type identification system, activation of software or an application utilizing the meeting type identification system, and/or the like.

The meeting type identification system may be made of multiple systems or modules that communicate together to make up the meeting type identification system or may be a single system. The meeting type identification system may be a standalone system, may be accessible through other computing devices, and/or a combination thereof. For example, the meeting type identification system may be a standalone system that can be accessed by a user and/or may be or provide an application that is accessible by a user on another computing device. The meeting type identification system may be accessible using any type of computing device, for example, personal computer, laptop computer, smartphone, tablet, smartwatch, head-mounted display, smart television or other smart appliance, augmented reality device, virtual reality device, and/or the like. Thus, the meeting type identification system may be accessible locally using a computing device where the meeting type identification system is installed and/or may be accessible remotely through another computing device. For example, the meeting type identification system may be accessed by a user using a device that communicates with the meeting type identification system to determine an attendee appearance type, provide recommendations related to meetings, access profiles for the meeting type identification system, and/or the like. However, the meeting type identification system may be located and operate on a different information handling device to perform the described steps.

The provision of recommendations to user with respect to a meeting in view of an attendee appearance type can be provided as a service to other entities or companies. In other words, the meeting type identification system could be stored on a server or network of a company and the system could determine attendee appearance types and provide recommendations for other companies or entities, with the other companies or entities paying for the determination of the attendee appearance type or use of the meeting type identification system. For example, a company may allow the service provider access to meetings and factors related to meetings so that the service provider could determine an attendee appearance type for meeting attendees. As another example, a service provider may store all of the historical information that is related to meetings and that may be used to make a determination regarding the attendee appearance type. The service provider could then make the determinations for the company or could allow the company access to the historical information so that the company could make the determinations. Thus, the service provider could provide the actual determining as a service or could provide resources to make the determinations, store information that is used to make the determinations, and/or the like.

The meeting type identification system may have an associated graphical user interface. The graphical user interface may be provided on a display or monitor, which may or may not be associated with the meeting type identification system. In other words, the meeting type identification system may have a dedicated display or monitor or may be accessible using any display or monitor. In either case, the meeting type identification system may provide instructions to generate and display the graphical user interface on the display device being used to access the meeting type identification system. The graphical user interface may also be updated and managed based upon instructions provided by the meeting type identification system. In other words, the meeting type identification system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the meeting type identification system. For example, the meeting type identification system may utilize an attendee profile, historical information, and/or the like, to determine an attendee appearance type for a meeting, to determine if meetings should be moved either automatically or with user input, the type of recommendations to provide, and/or the like. The graphical user interface may allow for creation of or access to these profiles, historical information, and/or the like, by allowing a user to input information regarding user preferences, meeting information, attendee information, and/or the like. As will be discussed in more detail, the use of user provided information is not the only way that the profile and/or historical information can be created. The meeting type identification system can then utilize these inputs to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, display recommendations, and/or the like. It should be noted that the information to be used by the meeting type identification system and information provided by the meeting type identification system can be different for different applications, different computing systems, different users, and/or the like. Thus, the information corresponding to input or output of the meeting type identification system are not always the same. However, the meeting type identification system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The meeting type identification system may utilize one or more artificial intelligence models in determining an attendee appearance type and providing a recommendation. Artificial intelligence models could be designed to perform the attendee appearance type determination, provide recommendations, or any other steps within the described system. Artificial intelligence models may also be used for steps within a step. For example, a model could be utilized to analyze factors of the meeting to determine an attendee appearance type, analyze user profiles to identify and provide recommendations to a user, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the meeting type identification system, or the artificial intelligence model may be a model that is created and trained from scratch. Since the meeting type identification system is used in conjunction with determining an attendee appearance type and providing a recommendation related to the meeting, some models that may be utilized by the system are analysis models, similarity identification models, language models, large language models, entity identification models, input analysis models, filtering models, classification models, and/or the like. The model may be trained using one or more training datasets. Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The meeting type identification system may include different components for carrying out different functions of the system, including different steps to be performed. These components may be hardware components or software components. Some hardware devices or components that may be utilized by the meeting type identification system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the meeting type identification system. For example, the meeting type identification system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the meeting type identification system, and/or the like.

One software component may include a data storage location that stores the information related to meetings, factors of meetings, historical meetings and factors, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by meeting type, grouped by attendees, grouped by recommendations, and/or the like.

Some other software components include a user profile that stores information related to user and user preferences. Within the user profile the user can identify information related to when the user might want the system to determine an attendee appearance type for a meeting and/or provide a recommendation related to a meeting. For example, the user may provide input to the user profile that indicates when the system should be deployed to identify meetings scheduled for the user and determine an attendee appearance type for the meetings. The user profile may also identify the types of recommendations that the user wants the system to provide. The user profile may also identify when meetings can be moved to other times and/or days. The user may also identify within the profile a priority of meetings, meetings that cannot be moved, meeting types that cannot be moved, meeting attendees that would result in a meeting not being allowed to be moved, the types of factors that should be used to determine attendee appearance types, a prioritization of factors, and/or any other information that the system may find useful in determining an attendee appearance type and/or providing a recommendation for a meeting.

Profiles can be populated with information manually by a user, meeting attendees, entities or companies, and/or the like, or can be populated over time as the system learns more about the user, meeting attendees, entities or companies, and/or the like. For example, a user may manually provide input to a user profile and the system can learn preferences about the user over time and populate the user profile with this learned information. Learned information may be information learned based upon direct inputs, for example, a user may be presented with a pop-up window in response to a trigger and provide input to the pop-up window. This input can be then populated into the user profile. Learned information may also be information learned based upon indirect inputs, for example, a user may provide inputs (e.g., audible inputs, visual inputs, gesture inputs, etc.) that indicate that the user would like to receive certain types of recommendations, indicate that the user is interested in identifying an attendee appearance type, and/or the like. The system can then aggregate this information to learn preferences of the user. With respect to determining an attendee appearance type based upon similar meetings or other meetings within a company or entity, the learned information may include historical information, correlations between factors and attendee appearance types as identified using the historical information (for example, using an artificial intelligence model to make these correlations), and/or the like.

At 301, the meeting type identification system may identify a meeting scheduled for a user. The user may have meetings scheduled to which the user has been invited. Since the user may choose to attend, tentatively attend, or decline a meeting, the system may determine the acceptance status of the meeting with respect to the user. In other words, the system may determine if the user has accepted, tentatively accepted, declined, or not responded to the meeting. In the event that the user has declined the meeting, the system may take no action with respect to the meeting. Alternatively, the system may analyze all the different meetings regardless of the acceptance status of the meeting. Whether the system analyzes all meetings or only those meetings having a particular acceptance status may be based upon information contained within the user profile or information provided by the user to the system.

To identify a meeting, the system may access an information source that identifies meetings of the user. The most common location for meetings is within a calendar or schedule. For ease of readability, a schedule will be described as the example here throughout. However, this is not intended to be limiting, as other information sources may contain information related to meetings for a user and any of these information sources can be accessed for meeting identification. The user may identify the different information sources that may contain meeting information, for example, within the user profile, by providing a link or pointer to the information source within the graphical user interface of the system, by linking the information source to the system, and/or the like.

Some example information sources that may contain meeting information include, but are not limited to, a stand-alone calendar application, an integrated calendar application (e.g., calendar application integrated with an email application, calendar application integrated with a video conference application, calendar application integrated with a personal assistant application, etc.), a schedule, communication applications (e.g., email applications, text messaging applications, instant messaging applications, etc.), and/or the like. In some examples, the meeting information may be included in a dedicated schedule or calendar portion. In other examples, the meeting information may be contained within a communication and the system will need to parse the information contained within the communication in order to identify the meeting information. To perform this analysis or parsing, the system may utilize any type of analysis or parsing technique, for example, an artificial intelligence model, entity identification technique, semantic analysis technique, syntactic analysis technique, text parsing technique, audio parsing technique, and/or the like.

In addition to identifying a meeting scheduled for a user, the system may identify information related to the meeting. Some of the information may be standard information related to the meeting including a date and time for the meeting. Additionally, the system may identify a designated location for the meeting, a title of the meeting, attendees who have been invited to the meeting, a number of attendees invited to the meeting, a user or entity who transmitted the meeting invitation, and any other information that can be gleaned from the meeting appointment itself. To identify this information, the system may utilize any input (e.g., text, audio, image, etc.) analysis and/or parsing technique and context analysis technique, which may include artificial intelligence models, rules engines, similarity analysis techniques, and/or the like.

In addition to the information that can be identified from the meeting appointment, the system may identify other information related to the meeting. In identifying this additional information, the system may not be able to directly glean the information from the meeting appointment. Rather, the system may infer the information, make correlations between direct information and inferred information, access information that is indirectly related to the meeting, and/or the like. Thus, the system may not only identify the information that can be directly pulled from the meeting appointment, but can also identify information that is indirectly identified from the meeting appointment. Identifying this indirect information may include utilizing one or more techniques that can infer information, make correlations between information, and/or the like. These techniques may include, but are not limited to, artificial intelligence models, rules engines or data stores, learning algorithms, and/or the like.

Some indirect information that may be identified includes, but is not limited to, a topic of the meeting, roles of attendees that are invited to the meeting, technical capabilities of a location of the meeting, historical patterns of attendee appearance type for meetings having a similarity to the meeting, crowdsourced patterns of attendee appearance type of meetings having a similarity to the meeting, and/or the like. Thus, not only can the system utilize historical information for the specific attendee, but the system can also utilize historical information for a company or organization in identifying the indirect information. The system may access different information sources to identify the indirect information, for example, organizational charts, titles of people from email or other communications, information sources related to different locations, and/or the like. The system may also perform analyses to determine some of the indirect information. For example, topics can be identified using entity identification, semantic analysis, syntactic analysis, artificial intelligence models, clustering techniques, and/or the like. As another example, the system may utilize parsing techniques to analyze email addresses and/or communications to identify a role of an attendee or identify a company that the attendee represents.

In identifying a similarity of meetings to other meetings, the system can utilize similarity identification techniques. Additionally, the types of information that are utilized for performing the similarity identification can vary between meeting types, can be identified by the user, can be learned by the system over time, can be identified through the historical patterns of use, and/or the like. Some information that the system may utilize for determining meeting similarity is a reoccurrence of a meeting, for example, if the meeting is simply a reoccurrence of another meeting, this subsequent meeting may be identified as similar, even if meeting attendees have changed, a meeting location has changed, or other information of the meeting has changed. Other information that the system may utilize for determining meeting similarity is meeting attendees, meeting locations, meeting organizers, companies or entities that are represented within the meeting, locations of attendees with respect to each other, and/or the like.

Different information may have different weights regarding the similarity analysis. For example, meeting attendees may have a higher weight than a meeting location, meaning that meetings having different attendees may be more likely to be considered dissimilar as compared to meetings having different locations. As another example, meetings having the same companies or entities represented may be more likely to be considered similar as compared to meetings having the same meeting organizer. These weights or prioritizations can be learned by the system over time, identified by a user or other entity, may be default values, and/or the like.

The user can also provide information related to meetings, for example, within the user profile, directly to a meeting appointment, directly to the system, through learning by the system, and/or the like. The user may provide information related to how the system should treat a particular meeting or groups of meetings. For example, the user can provide a priority for a particular meeting or types of meetings, provide a priority for meetings having particular attendees, identify that particular meetings or meeting types cannot be moved, identify that meetings having particular attendees or attendees having a particular role cannot be moved, provide a weighting for meetings, and/or the like. This information may be utilized by the system when determining an attendee appearance type and/or providing recommendations to the user.

The information that is captured both directly from the meeting appointment and from other information related to the meeting may be identified as factors of the meeting. Thus, the factors of the meeting may include, but are not limited to, a location of the meeting, a time of day of the meeting, attendees invited to the meeting, a topic of the meeting, a number of attendees invited to the meeting, a location of the attendees invited to the meeting, a historical pattern of attendee appearance type for meetings having a similarity to the meeting, crowdsourced information regarding an attendee appearance type for meetings having a similarity to the meeting, a location of the attendee, organizational chart information, identification of whether attendees are internal or external to an organization, a frequency or reoccurrence of the meeting, relationships of attendees with respect to each other (e.g., direct report, customer, service provider, manager, technical lead, etc.), roles of attendees within an organization, information the user has provided with respect to a meeting, technical capabilities of a location of the meeting, and/or the like.

At 302, the meeting type identification system may determine if an attendee appearance type can be determined. In other words, the meeting type identification system may determine, based upon the factors of the meeting, an attendee appearance type for the meeting. The attendee appearance type identifies how the user should appear at the time. Specifically, the attendee appearance type identifies the type of meeting and how the user would access and engage within the meeting. Thus, the attendee appearance type may include, but is not limited to, an in-person meeting, a virtual meeting with an image capture feed enabled, a virtual meeting with an image capture feed disabled, and/or the like. Virtual meetings not only include meetings conducted using video conferencing software (even if the video feed is disabled), but also includes telephonic conferences, virtual meeting room meetings, text-based meetings, or any other meetings type where users are connected over a network and are not physically present with each other. It should also be noted that some meetings may be hybrid meetings where some attendees are physically located together and some attendees are connected together virtually. In this case, the system is determining how this specific attendee should appear for the meeting, even if other attendees may appear differently for the meeting.

To determine the attendee appearance type, the system may utilize the artificial intelligence model, a recommendation engine, a rules database, a learning algorithm, direct user input, historical information, and/or the like, to make correlations between the factors of the meeting and an attendee appearance type. Different factors may have a stronger or weaker correlation on an attendee appearance type. The system could identify the strength of the correlation and use this strength to weight different factors, support a particular attendee appearance type, strengthen other correlations, and/or the like. As an example, the system may provide the factors as input to a recommendation engine. The recommendation engine can then output the attendee appearance type after analyzing the factors and making correlations between the factors and the attendee appearance type. As another example, the system may provide the factors as input to an artificial intelligence model. The artificial intelligence model analyzes the factors in view of the training of the artificial intelligence model. As output, the artificial intelligence model may provide the attendee appearance type and a confidence level corresponding to the attendee appearance type. Other analysis systems may also have provided confidence levels, for example, a rules engine, a learning algorithm, the recommendation engine, and/or the like.

The confidence level may provide an indication of how confident the system is with respect to a particular attendee appearance type determination. The system could also assign a confidence level to different parts of the determination. For example, the system may first determine whether the meeting is an in-person meeting or a virtual meeting. The system may assign a confidence level to this determination. If the system determines the meeting is a virtual meeting, the system may then determine whether it is a video feed enabled or video feed disabled virtual meeting. The system could then assign a confidence level to this determination. In providing the confidence level, the system may identify what factors contribute to the determination or confidence level. For example, the system could identify that specific meeting factors point to or cause the system to lean towards a particular attendee appearance type determination. The system could also identify that different meeting factors point to or cause the system to lean towards a different attendee appearance type determination. This could allow the user to quickly make a determination regarding the attendee appearance type based upon the identified factors. If the user makes a determination, the user could provide this determination to the system so that the system can utilize this feedback for subsequent attendee appearance type determinations.

What follows is an example technique for making the correlations. However, this is only intended to be an illustrative example technique as other techniques could be utilized. The system could identify an attendee appearance type for a historical meeting. The system could then identify the factors for that meeting. The system could perform a similar analysis for other historical meetings. The system could then determine the factors that are similar for meetings having the same attendee appearance type. The system could then analyze those factors to identify the factors that seem to be consistent between meetings having a particular attendee appearance type. This could provide an indication of a correlation between a particular factor and a particular attendee appearance type. It should be understood that other techniques for making correlations between meeting factors and attendee appearance types are contemplated and possible and this is only an illustrative example technique.

The system may utilize historical information of the user to make the determination of the attendee appearance type. The system may identify other meetings that the user has attended and identify the attendee appearance type for those meetings. The system may then identify factors that are the same between the meeting and the historical meetings and identify the attendee appearance type of those meetings having the same or similar factors. From this identified attendee appearance type, the system can make a determination of the attendee appearance type for the target meeting. In other words, the system can identify from historical meetings and attendee appearance types at those historical meetings, the attendee appearance type for the upcoming meeting. In making this determination, the system may make correlations between factors and attendee appearance types. In other words, the system may determine which factors result in a particular attendee appearance type.

To make more accurate determinations, particularly for meetings that the user has not previously attended, the system may utilize historical information of an entire company instead of only relying on historical user patterns for a user. The system may make correlations between factors of the meetings and previously conducted meetings where the attendee appearance type is already known since the meeting is already concluded. The system can identify factors that result in a particular attendee appearance type, thereby allowing the system to identify correlations between factors and attendee appearance type. The use of a rules database, artificial intelligence model, learning algorithm, and/or the like, will be particularly useful for making these correlations. As a simplified correlation example provided only for illustrative purposes, the system may determine that throughout the company, when a technical team meets with the legal team, the meetings are typically in-person meetings. As another simplified example, the system may determine that throughout the company, when a technical team meets among themselves, the meetings are typically virtual camera enabled meetings. Thus, the system can make correlations between information identified from the meeting, either directly or indirectly, and information regarding historical meetings, either of the user or of other users, to determine an attendee appearance type.

As a simplified example of making correlations and used only for illustrative purposes, the system could determine from the fact that the location is in a different geographical area than the location where the user works from, that the meeting is a virtual meeting. Obviously, other factors could change this determination, for example, if the user is traveling and is located in the geographical area of the meeting, then the meeting may be an in-person meeting. Another factor could be that specific meetings are ones that the user is expected to travel for, and if this is one of those meetings, then it is an in-person meeting, thereby overriding the difference in geographical area. Thus, as can be seen from this simplified example, the determination regarding an attendee appearance type could get very complicated.

If, at 302, an attendee appearance type cannot be determined, the system may take no action with respect to the meeting at 304. In other words, the system may not identify the attendee appearance type to the user or provide a recommendation to the user. The system may not be able to identify an attendee appearance type if there is not enough information related to the meeting to make such a determination. The system may also not be able to identify an attendee appearance type if the user or system has been provided with input to not make a determination with respect to a particular meeting. For example, the user may have identified (e.g., within the user profile, by providing manual input to the system, by marking the meeting, etc.) that a determination does not need to be made with respect to a particular meeting, with respect to meetings having particular attendees, with respect to meetings having only a single attendee, and/or the like.

If, on the other hand, an attendee appearance type can be determined at 302, the system may provide a recommendation related to the meeting in view of the attendee appearance type for the meeting to the user at 303. The system may identify or make a recommendation regarding the attendee appearance type for the meeting. This may include providing an indicator that designates the attendee appearance type for a particular meeting. One technique for doing this is to provide a graphical user interface on a display device and provide the recommendation within the graphical user interface. The system may also provide the recommendation using a non-visual mode, for example, as audible output, as haptic output, as video or image output, and/or the like. Using the graphical user interface example, the system may provide an overlay that includes the recommendation which may be the indication of the attendee appearance type. The overlay may be presented over the schedule or calendar of the user and may include an indicator that designates the attendee appearance type for each meeting. Thus, the indicator may be located so that the user quickly understands that a particular indicator is intended to go with a particular meeting.

For example, the overlay may include a circle that is colored a particular color for an attendee appearance type and the circle is overlaid onto the meeting appointment within the calendar to which it corresponds. As another example, the overlay may include a particular color that is overlaid onto the meeting appointment within the calendar to which it corresponds. Other visual indicators are possible, for example, different shapes, different shading, different textures, different animations, text, cross-hatching, and/or the like. The system could also provide a graphical user interface that is part of an application of the meeting type identification system. In this case, the information from the calendar or schedule of the user may be pulled into the application. The application may then render a calendar or schedule that includes the indicators embedded within the calendar or schedule. As should be readily understood, different techniques for presenting the information are contemplated and possible.

In addition to providing a recommendation regarding the attendee appearance type, the system may provide additional recommendations related to the meeting and in view of the attendee appearance type. One recommendation may be a recommendation regarding setting a reminder related to a task for the meeting and, if applicable, recommending a time for the reminder. For example, the reminder could be to leave the house at a particular time so as to leave enough time to travel to the meeting location, to start getting ready and dressed for the meeting at a particular time so as to leave enough time to have a desired appearance, to test meeting equipment before the meeting, to recommend what to wear to the meeting or what appearance the user should have for the meeting, and/or the like.

To make the reminders, the system could access secondary sources to identify different elements that may affect an attendance of the user at the meeting. For example, the system could access a map application, a traffic application, an organizational chart, information from a communication system, and/or any other secondary source that may provide information that could affect the recommendations. For example, the system could access a traffic application to identify how long it will take the user to travel to a particular location to make it to a scheduled meeting time. The reminder may then be set to account for this length of time and may then be provided at the time necessary for the user to make it to the meeting on time. As another example, the system may access an organizational chart and identify that one of the meeting attendees is an executive within the company. Based upon understanding that one of the attendees is an executive, a recommendation could be made to the user to dress more professionally than usual for this meeting due to the attendance of the executive.

The recommendation may also include identifying attendee appearance types for meetings that span over a predetermined time period, for example, a day, a week, a few days, a couple of weeks, a morning, a few hours, a certain time slot across a few days or week, an after-lunch period, and/or the like. The system could analyze the meetings and corresponding attendee appearance types holistically to identify any time frame or meetings having an attendee appearance types that are different than other meetings within the time frame. The system may then provide a recommendation regarding moving one or more of the meetings to a different time. In other words, the system may identify other meetings that are near, timewise, a meeting, and may then identify if the meetings within the group have the same or similar attendee appearance types. In the event of a dissimilarity between attendee appearance types for one or more of the meetings, the system could identify and recommend a different time for the meeting having the dissimilar attendee appearance time and either move the meeting automatically or request the user to confirm if the user wants the meeting to be moved to a different time or day.

The recommendation may only include identifying that the meeting has a different attendee appearance time and recommending to the user to move the meeting. In the affirmative, the system could then identify and recommend a time for movement of the meeting. In other words, the initial recommendation may include only the recommendation to move the meeting or may also include a time and day for movement of the meeting. Recommendations for moving meetings may be based upon a prioritization assigned to a meeting. A prioritization could identify those meetings which should take precedent and should not be moved or those meetings that are allowed to be moved. Recommendations for moving meetings may also be based upon information contained within the user profile, input provided by the user, information learned about the user over time, a number of attendees for the meeting, a number of attendees that have accepted the meeting, a frequency of reoccurrence, different factors of the meeting, and/or the like.

For example, the system could analyze a user's day and identify that all the meetings that day are virtual meetings except for a single meeting which is an in-person meeting. Additionally, the in-person meeting is scheduled in the middle of the other virtual meetings. This may mean that the user would need to travel to the location of the in-person meeting before the virtual meetings began, because the user will not otherwise have time to travel to the location of the in-person meeting before that meeting starts. The system could then provide a recommendation to move the in-person meeting or some of the virtual meetings, so that the user either does not have to travel to the in-person meeting location at all that day, or the person could travel to the location directly before the in-person meeting. Whether the system recommends moving the in-person meeting or the virtual meetings, or both, may be dependent upon factors of the meeting(s), information contained within the user profile, a prioritization of the meetings as identified in the user profile, user input, and/or the like. The recommendation may also identify a time or day to which to move the meeting, in the event that one or more of the meetings could be moved.

In addition to determining and making a recommendation regarding the attendee appearance type, the meeting type identification system may make additional recommendations and/or take additional actions. Additional actions may include configuring a device based upon the meeting type. Thus, the meeting type identification system may generate a configuration command to change at least one characteristic of a computing device associated with the user or attendee. The configuration command may be based upon the determined attendee appearance type. The configuration command can then be transmitted to the device of the user using a computer network.

As a first example, the configuration command may include making modifications to a network based upon the attendee appearance type. For example, if a meeting is determined to be a virtual meeting with the camera enabled, the system may alter a network policy of a computer network to prioritize network traffic from the camera device during a time of the meeting, during a time that the meeting is scheduled, while the camera is enabled, and/or the like. As another example, if the system determines that the meeting is a virtual meeting with the camera enabled, the system may configure the camera-enabled device to prioritize network traffic from a meeting application on the camera-enabled device during a time of the meeting, during a time that the meeting is scheduled, while the camera is enabled, and/or the like.

As a second example, the system may also perform one or more tests to ensure that needed meeting equipment will be available and functioning at the meeting time. For example, if the system determines that the meeting is a virtual meeting with the camera enabled, the system may automatically cause the camera-enabled device to perform a connectivity test between the camera-enabled device and a remote device and report the results of the connectivity test. Similar tests could be performed for other equipment that might be needed during a meeting, for example, connectivity tests for speakers, network connectivity tests, meeting conference software tests to ensure a connection can be made without requiring an update, and/or the like. The system may also identify a component that is connected and functioning to ensure that a virtual meeting will function correctly without the user needing to spend time figuring out which component is connected and which component to unmute, share video from, and/or the like. Similar testing or configuration can be performed for other types of meetings. For example, if the meeting is determined to be an in-person meeting, the system may configure a computing device to be able to connect to a wireless network associated with a meeting location of the in-person meeting. This configuration may occur before the meeting is scheduled to begin, so that the attendee can be ready for the meeting by the time the meeting starts.

As an overall non-limiting example of the described system, an employee who is new to a company may have a meeting scheduled with a customer. The employee is uncertain of the meeting type and, therefore, the attendee appearance type. In other words, the employee does not know if it is an in-person meeting or virtual meeting and how the employee should be dressed for the meeting. The described system identifies the meeting on the calendar of the employee and determines, based upon different factors of the meeting, the attendee appearance type. In this example, the system is able to access historical meeting information related to meetings that have been held with this particular customer for other employees of the company. Additionally, the system identifies that the location of the meeting is in a room that has seating for a small number of people and has capabilities that allow users to conduct video conference meetings. The system is also able to identify that the location is a forty-five-minute drive for the employee from home. These are at least some of the factors of the meeting that the system utilizes to determine an attendee appearance type.

Based upon these factors, the system determines that the meeting is most likely a virtual meeting with an enabled video feed. The system provides this information to the employee with a recommendation to the employee to dress in business casual for the meeting since the meeting, while virtual, will have an enable camera feed. Additionally, the system provides other recommendations to the employee. The system is able to identify that the meeting is at 9 am, so the system provides a recommendation related to setting an alarm related to when the employee should wake up in order to have enough time to prepare for the meeting. Additionally, the system recommends setting a reminder to test the meeting equipment of the employee so that the employee can have the equipment tested before the meeting is to begin.

As another overall, non-limiting example, a user may have a schedule with multiple meetings across the week. The system is able to determine the attendee appearance type for each of these meetings and provide the determination within a graphical user interface that overlays the schedule of the user. When the user opens the schedule, the user is presented not only with the schedule, but also with the overlay so that the user can quickly identify the attendee appearance type for each of the meetings. The system can provide recommendations for each of the meetings based upon the attendee appearance type. Additionally, the system is able to analyze the schedule and provide a recommendation for moving a meeting to a different time and/or day.

For example, the system may determine that the user has one in-person meeting scheduled for Tuesday, with the remaining three Tuesday meetings being virtual meetings. The system may additionally determine that the user has four in-person meetings scheduled for Thursday. Accordingly, the system may provide a recommendation to move the in-person meeting from Tuesday to Thursday, so that the user only has to drive to the physical location on Thursday and can work remotely on Tuesday. In the event that the user does not want to move the in-person meeting from Tuesday, the system may provide a recommendation regarding a new time for the in-person Tuesday meeting so that the user is not driving at a time of day that usually has heavy traffic, thereby reducing the travel time for the user. The user could ultimately decide whether to approve the move of the meeting or could decline the move of the meeting.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using a meeting type identification system, a meeting scheduled for a user;
determining, using the meeting type identification system and based upon factors of the meeting, an attendee appearance type identifying how the user should appear at the meeting; and
providing, to the user, a recommendation related to the meeting in view of the attendee appearance type for the meeting.

2. The method of claim 1, further comprising generating, by the meeting type identification system and based upon the attendee appearance type, a configuration command configured to change at least one characteristic of a computing device associated with the user; and
transmitting the configuration command to the computing device via a computer network.

3. The method of claim 1, wherein the determining the attendee appearance type comprises determining the meeting is at least one of: an in-person meeting, a virtual meeting with an enabled image capture feed, and a virtual meeting with a disabled image capture feed.

4. The method of claim 1, wherein the determining the attendee appearance type comprises providing the factors to a trained artificial intelligence model, wherein the artificial intelligence model is trained to analyze the factors of the meeting and is configured to output the attendee appearance type and a confidence level corresponding to the attendee appearance type.

5. The method of claim 1, wherein the determining the attendee appearance type comprises utilizing historical information corresponding to meetings having a similarity to the meeting.

6. The method of claim 1, wherein the providing a recommendation comprises identifying a different time for the meeting based upon the attendee appearance type and attendee appearance types for other meetings near the different time and recommending movement of the meeting to the different time.

7. The method of claim 1, wherein the providing the recommendation comprises a recommendation regarding an appearance of the user for the meeting.

8. The method of claim 1, wherein the providing the recommendation comprises identifying, by accessing a secondary source, elements that affect an attendance of the user at the meeting and wherein the providing the recommendation is based upon the elements.

9. The method of claim 1, wherein the providing the recommendation comprises providing the recommendation within a graphical user interface on a display device.

10. The method of claim 1, wherein the factors comprise at least one factor selected from the group consisting of: a location of the meeting, a time of day of the meeting, attendees invited to the meeting, a topic of the meeting, a number of attendees invited to the meeting, a location of attendees invited to the meeting, and historical patterns of attendee appearance type for meetings having a similarity to the meeting.

11. A system, the system comprising:
a processor;
a memory device that stores instructions that, when executed by the processor, causes the system to:
identify, using a meeting type identification system, a meeting scheduled for a user;
determine, using the meeting type identification system and based upon factors of the meeting, an attendee appearance type identifying how the user should appear at the meeting; and
provide, to the user, a recommendation related to the meeting in view of the attendee appearance type for the meeting.

12. The system of claim 11, wherein the determining the attendee appearance type comprises providing the factors of the meeting as input to a recommendation engine and wherein the output from the recommendation engine is the attendee appearance type.

13. The system of claim 11, wherein the determining the attendee appearance type comprises determining the meeting is at least one of: an in-person meeting, a virtual meeting with an enabled image capture feed, and a virtual meeting with a disabled image capture feed.

14. The system of claim 11, wherein the determining the attendee appearance type comprises providing the factors to a trained artificial intelligence model, wherein the artificial intelligence model is trained to analyze the factors of the meeting and is configured to output the attendee appearance type and a confidence level corresponding to the attendee appearance type.

15. The system of claim 11, wherein the determining the attendee appearance type comprises utilizing historical information corresponding to meetings having a similarity to the meeting.

16. The system of claim 11, wherein the providing a recommendation comprises identifying a different time for the meeting based upon the attendee appearance type and attendee appearance types for other meetings near the different time and recommending movement of the meeting to the different time.

17. The system of claim 11, wherein the providing the recommendation comprises a recommendation regarding an appearance of the user for the meeting.

18. The system of claim 11, wherein the providing the recommendation comprises identifying, by accessing a secondary source, elements that affect an attendance of the user at the meeting and wherein the providing the recommendation is based upon the elements.

19. The system of claim 11, wherein the providing the recommendation comprises providing the recommendation within a graphical user interface on a display device.

20. A product, the product comprising:
a computer-readable storage device that stores executable code that, when executed by a processor, causes the product to:
identify, using a meeting type identification system, a meeting scheduled for a user;
determine, using the meeting type identification system and based upon factors of the meeting, an attendee appearance type identifying how the user should appear at the meeting; and
provide, to the user, a recommendation related to the meeting in view of the attendee appearance type for the meeting.
